(19) United States
(12) Patent Application Publication
(10) Pub. No.: US 2005/0060207 A1
(43) Pub. Date: Mar. 17, 2005

(54) Claims paid insurance

(76) Inventors: James L. Weidner, Pasadena, CA (US); David Preimesberger, Los Angeles, CA (US); A. Peter Kezirian JR., Pasadena, CA (US)

Correspondence Address: MCDERMOTT WILL & EMERY LLP, 600 13th Street, N.W., Washington, DC, 20005-3096, US

(21) Appl. No.: 10/885,234

(22) Filed: Jul. 7, 2004

Related U.S. Application Data
(63) Continuation-in-part of application No. 10/140,434, filed on May 8, 2002.
(60) Provisional application No. 60/289,127, filed on May 8, 2001.

(51) Int. Cl. G06F 17/60

(52) U.S. Cl. 705/4

(57) ABSTRACT

A system, method, and device for indemnifying an insured party in a claims paid insurance policy. A premium allocation module determines a claims paid insurance premium for the insured party and a database module charges the premium to the account of the insured party. A policy operations module obligates the insured party to pay the assessed premium without an opportunity to cancel the policy after assessment. Although the insurer defends a claim against the insured party, the insurer is not responsible for the indemnity liability until the claim is resolved.

### RELATED APPLICATIONS

This application is a continuation-in-part of U.S. patent application Ser. No. 10/140,434, filed on May 8, 2002, entitled “Property/Casualty Insurance and Techniques,” which claims the benefit under 35 U.S.C. § 119(e) of U.S. Provisional Patent Application No. 60/289,127 filed on May 8, 2001, entitled “Professional Liability Insurance Techniques,” both of which are incorporated by reference herein in their entireties.

### TECHNICAL FIELD

This disclosure relates generally to property or casualty insurance, and more particularly, to a novel claims-paid insurance product, implementation and methodology.

### BACKGROUND

The Property and Casualty (P&C) insurance industry is a global industry which transfers the specific economic risks of individuals and businesses onto the society at large through the mechanism of insurance which is provided in exchange for a premium. The premiums charged reflect the perceived and historical record of risk of a particular loss from insured exposure and may protect the insured from either frequency of loss and/or severity of loss arising from natural perils such as windstorm, hail, flood, freeze or earthquake or from liability to third parties for negligent acts or omissions or for statutorily mandated coverages for employees work related injuries.

From its inception in the Lloyds Coffee House in 1688, where the risks of voyages were shared, “insured”, a major concern for the risk bearer(s) has been the recognition and estimation of losses sustained under any policy of insurance. Without knowledge of the losses sustained under a policy of insurance, it is impossible to establish an economic premium for either the insured or the insurer. The premium charged must adequately provide for the anticipated losses under the policy, the expenses of policy origination (such as agent's commission, taxes and other fees imposed by the state), general and administrative expenses of the insurer and the insurer's margin of profit.

From the earliest days of insurance, the losses which took place, “occurred”, during the period of the policy that gave rise to a claim as of the date of the loss occurrence. For certain types of claims, such as losses from fire or earthquake, the date of loss would be easily ascertainable. For other type of losses, such as third party liability arising from a defective product, the loss occurrence may not be recognized or known for a period of years after the date of the loss occurrence, thus this delay in recognition of a loss creates the necessity to establish reserves for liabilities. For example, the value of the building may be reasonably determined as of the date of loss, but the cost to replace it may not be known until well into the course of reconstruction. Thus, the insurer establishes reserves based on estimates of the cost to fulfill the obligation under the policy. The amount reserved can be too large or too small in any given case.

For policies where the losses are not yet known and have yet to be reported to the insurer, the insurer makes an estimate of these future liabilities based on past experience and the prior history of the length of time it has taken for losses for a particular class of insured to emerge and be reported. Thus, the insurer establishes reserves for known claims and for claims that are unknown and not yet reported, referred to in the industry as “Incurred But Not Reported” or “IBNR”. If the insurer fails to include these estimates of liability, the profit of the company is overstated and over time the cumulative effect of years of underestimation of reserves results in the potential financial impairment of the company.

To improve the methodology of reserving, actuarial science developed various quantitative and statistical methods to establish reserves based on historical and projected outcomes using probability theory. Because these studies incorporate projections and are based on assumptions about emergence patterns of claims and interest rates for example, there can be substantial disagreements over reserve levels. Arguments over these estimates have created additional torts that further complicate the insured/insurer relationship. As reserve levels are incorporated into the rate making process, these estimations frequently negatively impact the cost to the insureds and result in an “affordability crisis”.

As our society has become more complex, the nature of the risks in the insurance industry has grown as well with greater breadth and scope of coverage required by the insureds. Consequently, the premium costs have risen and the understanding of what the policy covers has declined. Both of these issues lead to more conflict with insureds over policy interpretation and claims settlement. Similarly, the capital required to support a portfolio of diverse risks has increased leading to the creation of large well capitalized insurers created in either stock or mutual company form.

Concurrent with the increased complexity of risks insured, was the advancement of new legal theories about negligence and appropriate compensation levels for injured parties. The new legal theories have had the effect of reshaping and increasing the potential liability of policies issued years or even decades earlier. The retroactive review of policy language and the litigation among carriers and policyholders consumed funds that could have been spent to compensate damaged individuals. The divergence in the industry generated a level of mistrust, waste and harm due to delay and uncertainty. This increase in claims under occurrence policies created a substantial mismatch of premiums and ultimate claims for any policy with its cumulative effect through time. These increased losses lately recognized by insurers produced losses in the current financial reporting period.

This problem was especially acute in third party liability lines of coverage such as general liability, professional liability including malpractice, and errors and omissions coverages. These lines of business then experienced substantial increases in premiums in the best case and withdrawal of insurance capacity at any price in the worst case; both instances damaged the insured/insurer relationship. This period of market discontinuity commenced in the middle 1970's and climaxed in 1986 and 1987 when occurrence coverage forms of insurance all but vanished from the market place.

In light of these problems, an alternative coverage form was created, “claims made”. Under a “claims made” policy, the policy in effect when the claim becomes known and “made” on the policy is the one responsible for the payment of the claim. A claim which may have occurred decades prior becomes the responsibility of the policy then in effect. The claim is thus shifted to a policy issued in later years. Thus, if the insured does not report claims during the policy period, the insured is responsible for that claim unless the insured has a policy in force when the claim is reported and made. Because the current policy is responsible for the claims reported in the current period, the establishment of the rate for the coverage is more predictable as there is not the need for substantial estimation in the rate making process. The reserving process is simplified to deal with reported or known claims. This type of rate making is inherently more stable.

However, over time the rates for a claims made policy begin to approach the rate for an occurrence policy on a policy continuously renewed. The policy attracts losses over the longer period it has been in force in a manner similar to an occurrence policy. It is generally believed in the industry that the claims made form offers the insured greater price and coverage stability as well as a greater likelihood that the carrier will continue to offer coverage given the greater certainty of the claims attaching to the policy. However, as losses to the claims made policy eventually approach the losses on the occurrence form, the cost of claims made policy increases resulting in the same issue of premium affordability for the insured. What is needed is a product that maintains its affordability and predictability through time and provides the insured with protection against the risk of non-renewal by the insurance carrier.

### SUMMARY

The claims paid policy functions similarly to the claims made policy with at least one important difference; the insurer does not become obligated for payment until the claim is settled and paid on behalf of the insured. The insurer thus does not bear the risk of adverse development inherent in the loss reserves. The removal of this risk removes any policy's greatest unknown and unquantifiable feature for which no charge need be made. Conversely, the insured retains the risk and responsibility for subsequent claims development and amount. The policy therefore is a “cash” policy representing premiums received less claims paid plus expenses paid out. Thus, the pricing for greater uncertainty is avoided, which enhances the price attractiveness to the insured. Changes in policy pricing is driven by the actual claims paid in the policy period not the substantial estimations necessary in occurrence or claims made policies.

Additionally, the claims paid policy has the bilateral effect of obligating insurer and insured to maintain the policy for the following exemplary reasons:
1. If the insured cancels, replacement coverage must provide protection for prior occurrences possibly stretching back years for both known but unpaid losses and unknown losses which is generally an expensive coverage.
2. If the insurer cancels, the policy obligates the insurer to offer protection for known or unknown claims to the insured, sometimes referred to as “tail coverage” without payment of an additional premium.
3. The insurer is entitled to change a premium which covers the claims paid in the policy period through the assessment mechanism of the policy upon the insured, which has previously obligated itself to such an assessment.

The claims paid policy provides coverage on an affordable and adjustable basis, and provides incentive for both parties to the contract to continue their relationship through time. The alignment of interests in these policies is superior to that in other products.

In one aspect, a method for insuring a property or casualty loss of a party with a claims paid insurance policy includes determining the claims paid insurance premium and charging the premium to the insured party. The insured party is obligated to pay the premium without an opportunity to cancel the policy. The method also includes receiving payment of the premium from the insured party and assuming liability for a claim against the insured party responsive to the claim being resolved.

In another aspect, a system for insuring a property or casualty loss of a party with a claims paid insurance policy includes a premium allocation module, a database module, and a policy operations module. The premium allocation module determines a claims paid insurance premium for the insured party. The database module charges the premium to the insured party. The policy operations module obligates the insured party to pay the premium without an opportunity to cancel the policy, receives payment of the premium from the insured party, and assumes liability for a claim against the insured party responsive to the claim being resolved.

In a further aspect, a computing device for modeling a claims paid insurance product includes a risk pool module, a cost module, and a risk analysis module. The risk pool module identifies collective risk for a group of entities. The cost module forecasts expenditures based on claims asserted against the group of entities. The risk analysis module evaluates a reserve funding amount.

Further features of the invention, its nature and various advantages will be more apparent from the accompanying drawings and the following detailed description.

### BRIEF DESCRIPTION OF THE DRAWINGS

The accompanying drawings illustrate several embodiments of the invention and, together with the description, serve to explain the principles of the invention.

FIG. 1 is an interaction diagram that illustrates the indemnification model according to an embodiment of the present invention.

FIG. 2 illustrates a computing device and object model abstractions for a claims paid insurance system according to an embodiment of the present invention.

FIG. 3 is a block diagram of a computing device according to an embodiment of the present invention.

FIG. 4 illustrates program code modules for an embodiment of the present invention.

### DETAILED DESCRIPTION OF THE EMBODIMENTS

The present invention is now described more fully with reference to the accompanying figures, in which several embodiments of the invention are shown. The present invention may be embodied in many different forms and should not be construed as limited to the embodiments set forth herein. Rather these embodiments are provided so that this disclosure will be thorough and complete and will fully convey the invention to those skilled in the art.

A. Overview

In an embodiment of the present invention, an indemnification model in the form of claims paid insurance is provided. A claims made or occurrence-based insurance policy transfers indemnity liability to the insurer before the claim is resolved. Because it may take many years for a claim to reach resolution, an insurer must reserve some present funds to pay for these long-term expected losses and as discussed previously, the accuracy of the reserve funds has been difficult to ascertain. In a claims paid insurance policy, however, liability for indemnifying the insured does not become the responsibility of the insurer until the claim is resolved. At that point, the real cost is known and is paid by the insurer. This reduces the need for the insurer to reserve present funds to pay for future long-term losses; collected premiums are used to cover “short-term” liabilities only. (Short-term and long-term liabilities for insurance purposes reflect the maturity date for payment. By definition, a long-term liability reflects an obligation that has a maturity or payment date greater than 12 months.) One advantage of this form of insurance is increased cost effectiveness and accuracy. It gives the insurers the ability to adapt to severity and frequency changes of known claims, while encouraging increased safety from the group or community of insured parties.

To explain the principles of the present disclosure, the following description relates to four attributes of a claims paid insurance methodology, namely: (1) the trigger or timing model for the transfer of the indemnity risk from insured to the insurer; (2) the ability to collect additional premium if more funds are needed to cover the insured risk; (3) the insured's vested right of renewal; and (4) a non-cancelable obligation of the insured to pay their insurance bill once the premium has been charged.

1. Triggering the Transfer of Indemnity Risk

At its core, P&C insurance is about risk transfer and defining where that transfer occurs. For an occurrence-based policy, the risk transfer is at the point or time the loss happens The insured reports the loss when it is discovered, but the liability shifts at the time the event occurs. As such, an insurer may not learn that it has this liability for many years. Occurrence coverage does not differentiate between known or unknown claims; and thus an insurance company must reserve for both. Companies are forced to estimate and study industry trends to deal with a problematic situation. All insurance used to be on this form, until it became too unwieldy and expensive for many perils. The claims made form was developed in response to the operational and accuracy complications arising from the occurrence form.

Under claims made, liability transfers to the insurer upon report of a claim by the insured. Claims made insurance imposes the burden of reporting on the insured and the insurer is the responsible for these known losses. With this immediate transfer of liability, an insurer must collect and hold reserves based on actuarial estimated costs of these reported claims. Both forms are used for short- and long-tail risks (even short-tail risks are long-term liabilities). For both forms, premiums need to be charged and funds held against the ultimate cost of known claims and the future costs for unknown claims. At the end of each year, the claims are reevaluated, reserves are checked for adequacy and adjustments are made in the premium for the following year (with no assurance of policy renewal). As part of this process, insurers also look to future trends and developments in the industry, but the emphasis is on past reserves and premiums are adjusted to reflect development trends in open claims. For long-tail liabilities, the average P&C insurer evaluates between 2-6 different policy years to set premiums for the approaching policy year, because reserve estimates are made at a claim's earliest most undeveloped stage and then constantly reviewed and adjusted as losses mature. If there is a gap in the funding of reserves, future premiums are charged to address the past shortfalls.

Delaying the transfer of indemnity liability has several advantages. First, a claims paid insurer that does not collect reserves in advance of payment will be able to charge significantly less premium than a claims-made or occurrence insurer, and that premium charge will be more accurate and will reflect the losses of the risk pool that actually caused or suffered the claim. The price difference between occurrence and claims made coverage for the same insurance product can range up to 50% and the price difference between claims paid and claim made may also fall into a similar range. The price savings and accuracy of the cost are significant Second, an insured can report a claim to an occurrence or claims made insurer, change companies and the former insurer remains financially liable for the cost of this claim. However, if an insured were to report a claim and then change insurers, the claims paid insurer would no longer be responsible for the indemnity portion of this claim. The insured would remain liable for any loss that may arise.

Third, a claims paid insurer enjoys a higher retention rate than its fellow claims made or occurrence insurers. Insureds with open claims would remain insured with a claims paid insurer to preserve converage for the indemnity liability, while those without open claims are incentivized to remain with the claims paid insurer because of the price advantage generated by the difference in forms. Individuals each have their own tolerance of risk; people still purchase occurrence coverage, despite the pricing, because they are more risk adverse than claim made insureds. Claims paid insurance offers a third option to the overall P&C insurance marketplace.

Insurance crises occur when perils become more risky due to court decisions, legislative of regulatory initiatives or changes in the expectations or practices of the insured. Some of these developments are rapid and others are evolutionary. Nevertheless, if the frequency or severity of the risk grows, a insurer has a limited ability to correct its reserves and therefore often non-renews its policyholder and exits the business. Claims paid insurance gives the insurer the ability to respond and remain a provider of coverage in the market while simultaneously providing economic savings to the insured.

As described above, in a claims paid policy, the indemnity claim cost does not become the responsibility of the insurer until the matter is resolved. At that point, the real cost is known and paid by the insurer. This delayed transfer could be as little as one year or as long as 10-15 years depending on type of peril. Because the liability has not been triggered, the insurer does not have the obligation and therefore does not have the right or need to collect for this loss. No indemnity is sought nor held; the insurer has a contingent obligation to the insured, but it is not liable for the loss. To succeed, the claims paid insurer must accurately estimate the funds needed to cover the indemnity losses for the current year plus other operational and related costs. It grants the insurer the flexibility to address risk relativity throughout the claims process without the limitations imposed by the claims made or occurrence reserving process. The insured benefits because it is not funding reserves today for expected future claim losses or inaccuracy of pricing reserves.

The defense and other allocated costs for claims paid insurance are treated in the same manner as for claims made insurance. The liability for these expenses is transferred from the insured to the insurer upon report and represents a minor portion of the overall premium expense to the insured. Furthermore, these costs are subject to less variation when compared with indemnity losses.

2. Ability to Collect Additional Premiums

One aspect of claims paid insurance is the ability for the insurer to assess for additional premiums if the short term calculation of need proves to be inadequate. Assessability, or the ability to seek additional premiums, is an accepted policy provision in the traditional insurance industry. Many new companies use assessability to provide comfort to insureds and third parties that require insurance as a condition to operate or participate. Under a claims paid methodology, assessability is used as a safety measure to insure that there are sufficient funds to cover the losses for a particular year. Of course, it is desirable to avoid assessments, and they can be limited in a variety of manners that are consistent with the insured peril as well as the particular insurance policy language.

In an embodiment, there is no set percentage or degree of risk tied to assessability. It can range from unlimited liability for future monies to a percentage of the most recent premium charge. As one skilled in the art will appreciate, assessability may be adapted to the characteristics surrounding a particular peril or coverage. Assessability is an established and available component of occurrence and claims made forms in today's insurance industry.

3. Insured's Right to Renew

A component of the claims paid insurance policy is that renewal rights are granted to the insured. Therefore, if a insured has an open claim, the insured has the option to continue coverage with the insurer, at the insurer's price. If the claims paid insurer retained the non-renewal right, then there is the possibility that an insurer would simply non-renew any policy that had an open claim and never be responsible for any claim. This scenario is inherently unfair and anathema to the purpose and intentions of insurance.

In the P&C insurance industry, non-renewal is a cudgel wielded to control size, scope and parameters of a particular line of business. A insurer has the ability to enter and exit markets at will because it has the right to non-renew its policies. Under the claims paid form, the insured has the renewal right. As explain above, the insured must have this right so that the insurer remains in place to see the open claim through to resolution.

Furthermore, a insurer without the power to non-renew must be certain that it understands and is willing to accept risk from a potential insured. By empowering the insured, a insurer puts a premium on its underwriting skills and its risk management department to understand the universe of perils and to help the insured, once accepted, to avoid claims. As one skilled in the art will appreciate, claims paid insurers will not only carefully select its insured, but also impose risk management regimes on these entities so that losses can be reduced or avoided. Insureds, seeking this insurance and the pricing advantage, are more likely to comply with programs that improve safety. By granting the power of policy renewal to the insured, a virtuous cycle may be created: the fundamental and traditional elements of insurance—underwriting, risk management, claims handling, and member service—are reemphasized, which leads to fewer losses for the benefit of the insured and the community, which can lead to lower premiums and more risk management to prevent future losses. Claims paid can create a system of heightened safety and cost savings, both arguable unattainable in the P&C industry.

This potential result differs from the claims made situation. Growth is calculated in terms of premium volume because an insurer is secure that it can exit a risk at a time of its choosing. The traditional elements of insurance are subjugated to premium growth and can lead to pricing protections that lead to cross-subsidization among various lines of insurance. When the results deteriorate, insurers non-renew insureds, capacity for this risk shrinks and individuals are left without insurance. The consequence of this chain of events negatively impacts all parties: society has less coverage for a growing risk, insureds are uncovered through no fault of their own and insurers have changed their business because they have no other ability to remedy their poor results. Under claims paid insurance, a insurer cannot exit the line, must charge the appropriate price for the risk, and is incentivized to help its insured to avoid losses.

In an embodiment, the insured's renewal right however is not absolute. Under claims paid, if the risk of a particular insured is so great as to the imperil other insureds, the insurer may review and eject this risk by terminating the policy. However, upon cancellation, the claims paid insurer provides full claims made tail coverage for all open claims, even if the policyholder has become an unacceptable risk. The effect of this provision is to impose a significant economic penalty on the insurer and to put the cancelled insured in the same if not better economic situation as if it were non-renewed from a claims made insurer.

4. Non-Cancellation by the Insured

In an embodiment, the insured is obligated to pay the charged or assessed premiums and does not have the right to cancel the policy during the term of coverage. Claims paid insurance relies on the ability to collect funds from a predetermined number of insureds to pay for the expected losses received for a fixed period of time. The insurer must collect the premium from each insured to cover the losses resolved during the policy period. Without this ability to rely on payment, the claims paid insurer would need to revert to claims made practices in order to meet its obligations to all of the other insureds.

A claims made insurer has already reserved for future losses; the funds were set aside when the claim was reported. In one scenario, if the insured cancels, the claims made insurer should have already collected sufficient funds to meet any obligation already incurred. It is charging higher premiums to grant this cancellation right to its insured. A claims paid insurer has a collection risk, but this element is mitigated by the limitations of the insured's obligation to pay what is built into the policy form. Of course, this right to collection extends to any assessability charges that may also arise.

B. Indemnification Model

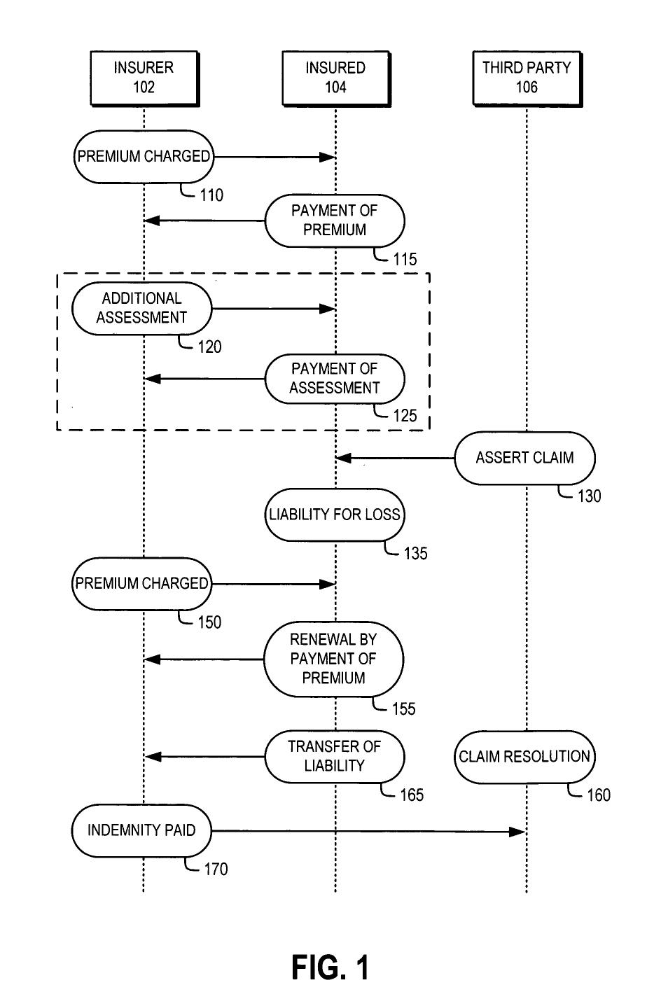

FIG. 1 is an interaction diagram that illustrates the indemnification model according to an embodiment of the present invention. The diagram includes three entities: an insurer 102, an insured 104, and a third party 106. The insurer 102 charges a premium 110 to the insured 104. As described in an embodiment above, the insured 104 has an obligation to pay 115 the policy premium once it has been charged. The insurer 102 is also capable of making an additional assessment 120 to supplement the reserve fund for the current policy year. Accordingly, the insured 104 pays the assessment 125. The assessment 120 and corresponding payment 125 are illustrated in dotted lines, which represent that these events are optional, and in an embodiment of the invention, rarely made.

At some point in time, the third party 106 asserts a claim 130 against the insured 104. As described above in an embodiment of claims paid insurance, the liability for loss 135 stays with the insured 104 until the claim is resolved.

During the time period that the claim is open and pending against the insured 104, other interactions may take place between the insurer 102 and the insured 104. For example, a policy renewal event is illustrated. Subject to a risk review by the insurer 104, the insured 104 has a right to renew the policy. The insurer 104 charges 150 a premium to the insured 104. The insured 104 renews by payment of the premium 155. After the premium has been calculated and charged, the insured 104 has an obligation to pay the premium.

When the claim by the third party 106 is resolved 160, the liability for indemnifying the insured 104 transfers 165 to the insurer 102 as a short-term obligation. The insurer 102 then pays 170 the resolved value of the claim to the third party 106.

C. Economic Model

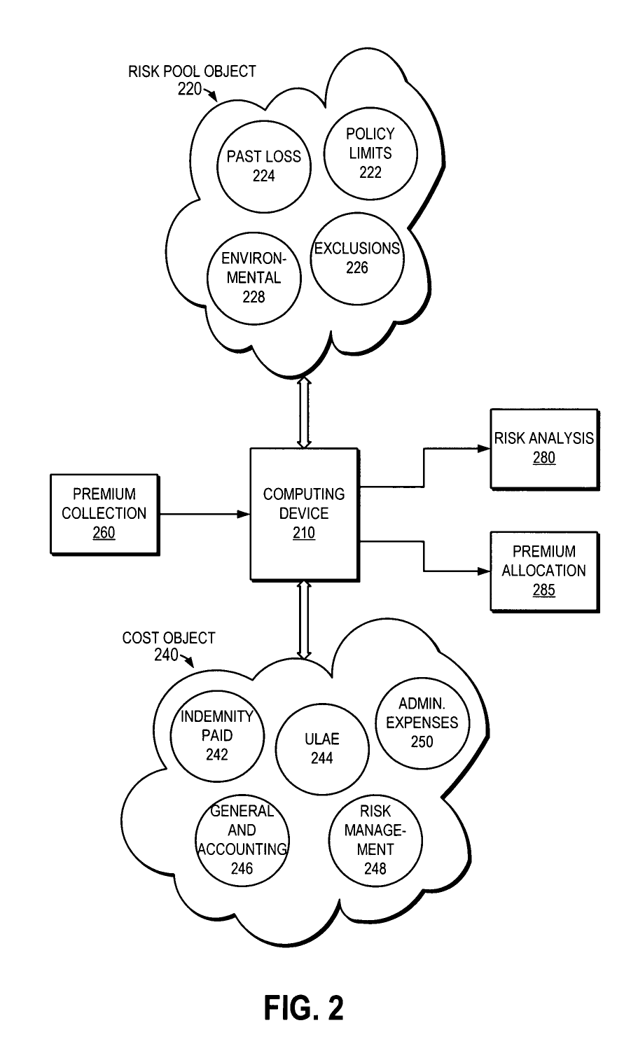

Claims paid insurance offers the benefits of lower pricing, insured fairness, increased safety and economic efficiency. These advantages are achieved through an integrated policy that reverses certain practices of the traditional insurance carriers. More importantly, these alterations have economic value that are achieved through the use of computer modeling/trending as well as through a pricing exercise that advances the current state of the P&C insurance. An object model abstraction for a claims paid insurance system is described in further detail below and with reference to FIG. 2. Claims paid may not be appropriate for all insurable risks; however, it provides another risk financing product that addresses certain needs of insureds and insurers.

Each insurance peril has a different claim maturation curve; the claims-paid form focuses upon the next 12 months of this process and its success in the marketplace depends on the ability to price the risk properly. Effective pricing is dependent on effective modeling and the incorporation of multiple points of data. It is an exercise that is completed in a compressed time period and requires unusual accuracy. Claims development is fluid and can vary greatly between accident years. The ability to harness computing power that will give insurers the comfort to rely on a claims-paid format is critical. Regulators understand that traditional reserves have a margin for error that is corrected in subsequent years. Since technology will allow an insurer to demonstrate that most, if not all, potential developments have been contemplated in the claims-paid calculation, a regulator will understand that the balance of risks has been properly considered and that consumers can purchase a claims-paid product with the assurance that a particular risk has been analyzed appropriately.

In general, claims-paid insurance is a more current process that looks forward rather than dwelling on past reserves to estimate the future cost of claims. Traditional P&C insurance insurers determine current year pricing by seeking to correct for error in past reserves. For a claims paid insurer, the focus is a look forward to the next 12 months to determine what claims should be resolved and what will be the expected indemnity losses. The following is a description of the pricing modeling process for a claims paid insurer. Like the policy provision description above, there will be some similarities between the claims paid form and the claims made and occurrence forms. However, in an embodiment of the present invention certain usual and customary practices are reversed to generate a more accurate product that benefits all parties in the insurance cycle.

FIG. 2 illustrates a computing device and object model abstractions for a claims paid insurance system according to an embodiment of the present invention. The illustrated embodiment includes a computing device 210, a risk pool object 220, and a cost object 240. The risk pool object 220 and the cost object 240 are operatively coupled to the computing device 210. Although the objects 220, 240 are illustrated as separate entities that are coupled to the computing device 210, one skilled in the art will recognize that the objects 220, 240 represent data abstractions that may reside in the computing device 210. That is, the objects 220, 240 may be manipulated by and persistently stored by the computing device 210. The computing device 210 also receives as input a premium collection 260 and produces outputs of risk analysis 280 and premium allocation 285.

1. Risk Pool Object 220

The first step in creating an insurance line is the determination of the risk pool. For all insurance products, there needs to be a sufficient grouping of similarly-situated risks that can collectively shared the burden of the expected losses. For claims paid, the decision to enter a business line has long-term consequences; entrance means that the insurer will remain committed to this business for the long-term and is willing to dedicate resources on an upfront basis in underwriting and risk management to generate future success. In the context of the present invention, the risk pool object 220 is evaluated in terms of one or more of the following factors: policy limits 222, policy exclusions 226, geographic and environment elements 228, and characteristics of the target insured. The prospective insurer studies and evaluates past loss experience 224 with a focus on severity and frequency trends. A growth calculation should also be included since new insureds will incur additional costs. All types of insurer should and many do study new markets to this extent, however, the barrier to entry is higher for claims paid insurer due to its limited ability to exit. The advancement of more powerful analytical tools allows a insurer to evaluate more information in a more careful manner than has previously been available.

2. Cost Object 240

Identifying a risk pool is a simple and straight-forward step that is familiar to all insurers. Where a claims paid insurer diverges from claims made and occurrence is in modeling practices in the determination of indemnity paid 242 for a current insurance year. At its most basic level, the claims paid insurer makes this calculation while the traditional insurers do not. They make different cost estimates which a claims paid company does not need to determine. Under the claims paid operations, the insurer looks at the indemnity losses that are expected to be triggered in the coming policy year. These claims were reported in earlier years, and have been managed judiciously by the claims operation. The claims payments expected to be made in the coming are totalled up and compared against the projected ultimate losses by exposure year. This actuarial exercise is important because it helps to determine how the insurer's risks are performing against each other and the marketplace. Armed with these reports, the claims that expected to be triggered are also compared against historical patterns to help shape and evaluate risk relativity within the insurer's risk pool and compare it against industry averages. With this analysis, a insurer can determine the total monies needed for indemnity in the current year and adjust risk relativity to reflect book and industry changes.

Any claims paid insurer, each internal risk class, assuming sufficient size, should have a similar if not identical loss ratio. Under the claims paid format, it is inherently unfair for one class should not have an advantage over another risk class. While not required for this invention, internal risk balance is favored and helps assure insureds of the overall impartiality of the pricing practice, and generates a more accurate cost allocation.

Once the total indemnity need is determined as well as the internal risk relativity, various model assumptions and potential scenarios are tested and analyzed to insure stability for the insurance product. Growth projections can be included in these assumptions and scenarios. Subject to these results, the projected indemnity paid component is adjusted and becomes a component for policy year premium.

The claims made and occurrence insurers do not make this same indemnity calculation. Rather, they review past reserves and adjust the reserves, if necessary, for all claims, regardless of whether these claims are to be paid within the next year. These insurers then evaluate the success of the reserving process, make any necessary adjustments and then estimate the results for the claims that will be reported in the coming year. For the occurrence insurer, there will be a reserve for the unknown claims that will come due in future years. Sometimes other factors such as investment returns and taxes determine the timing of reserve adjustments, rather than performance of the reported claims.

The calculation of the ultimate loss adjustment expense (ULAE) component 244 is similar for all three forms of insurance. ULAE is the calculation for the expenses a company will incur during the claims management process. The various factors include determining the exposure period, modeling of loss cost trends and potential outcomes, and reviewing payout patterns and prior periods' development. While all three forms require a similar estimation, there is an important difference—for which claims are the current premiums to pay. For a claims paid insurer, even though it accepts the costs of defense upon report, there is still a greater emphasis on claims to be triggered within the next twelve months, while claims made and occurrence insurers look to the whole cost of all claims will or could be reported in the next year. As a result, claims management may be a larger percentage component of the overall premium for a claims paid rate than in a claims made or occurrence situation.

The calculation of the general and accounting expenses 246, risk management or underwriting expenses 248, information systems and other expenses (collectively administrative expenses 250) are similar for all types of insurers. Claims paid insurers have the same components as traditional insurers. However, the difference lies on the different funding horizons for each policy form and the importance these elements play in operations of the company. For claims made and occurrence companies, the ability to exit a product line is always available. These types of insurers have the luxury of making short-term forays into a product line. A claims paid company has no such freedom and therefore, additional stress and reliance is placed on the usual and customary insurance practices represented by this cost component. Expect claims paid insurers spend a greater percentage of their collected premium on underwriting, risk management and policy service than the traditional claims made or occurrence insurer.

Risk Unit Charge for a Policy Year: Once the risk pool has been determined and the indemnity, ULAE and Administrative costs have been tested and calculated, all facts are combined to develop the overall premium for the coming year. Adjustments are made for investment income and the premium distribution is tested and modeled on a variety of factors maturity, risk unit, regional, class specialties and other policy specific risk parameters. Ultimately, a total premium is determined and allocated within the risk class. This premium covers a cost that is dissimilar to the claims made and occurrence form in two significant manners. First, it will be less expensive on a risk basis than a properly-priced claims made or occurrence form by a factor ranging from 25-50%. Second, the vast majority of the dollars collect by a claims paid insurer will be spent in the immediate policy year, while the majority of the revenues collected by claims made or occurrence insurers will be held in reserves, while other reserves will be released to cover the insurance of the traditional insurers. Investment income remains a more important elements for the traditional insurers, while the claims paid de-emphasizes this source of revenue and rather seek lower premiums.

A claims paid pricing determination model can be outlined as follows in accordance with an embodiment of the present invention.
I. Risk Pool Determination
   1. Determine insurance components and nature of risks to be underwritten including but not limited to the following
      i. policy limits,
      ii. exclusions,
      iii. geographic/environment elements,
      iv. size of insured and/or
      v. Past loss experience (frequency and severity components inherent to the peril).
      vi. Exposure Period (prior acts)
   2. Aggregate similarly-situated perils into identifiable insurable risk categories.
   3. Incorporate trending and other actuarial methodologies for future expectations
II. Determine Indemnity Paid component for current policy year pricing.
   1. Determine projected current policy year indemnity exposures based upon expected triggered indemnity losses (actuarial/analytical).
   2. Review projected ultimate losses by exposure year (actuarial).
   3. Apply historical payout patterns to each exposure year (computer/table).
   4. Calculate current policy year projected Indemnity Paid component utilizing payout patterns and exposure years (computer).
   5. Model assumption and analyze potential scenarios. Select most likely and appropriate outcome, which includes comparisons to known industry practices/experiences.
   6. Adjust projected Indemnity Paid component by known resolved claims and other experience factors to determine Expected Indemnity Paid amount (computer/analytical).
III. Determine ultimate loss adjustment expense component for current year claims and any adjustments for prior year claims for current policy year pricing.
   1. Determine projected current policy year exposures (actuarial/analytical).
   2. Review projected ultimate loss expense by exposure year (actuarial).
   3. Review payout patterns and prior years' development for any adjustment to current policy year pricing (computer/analytical).
   4. Calculate ultimate loss adjustment expense component for current year (computer/analytical).
IV. Determine other underwriting, risk management and administrative expenses for current policy year pricing.
   1. Utilizing a budgeting process, determine expenses for the year in underwriting/policy services, marketing, risk management, finance, claims services, information services and administration (computer/analytical).
   2. Review for any non-cash or capital expenditures and adjust the underwriting and administrative component appropriately (analytical).
   3. Evaluate for credit quality of insureds
V. Calculate the per policy charge for the current policy year.
   1. Combine the Indemnity Paid component, ultimate loss adjustment expense component, and underwriting and administrative expenses for current policy year (computer/analytical).
   2. Adjust amount by investment income, other non-operating charges, retrospective charges (including additional assessments) and any profit margin (computer/analytical).
   3. Allocate premium total to individual policies based upon the following factors (computer):
      a. Risk relativity
      b. Risk maturity
      c. Regional or risk specialty adjustments
      d. Policy-specific risk experience adjustments

D. Computing Device 110

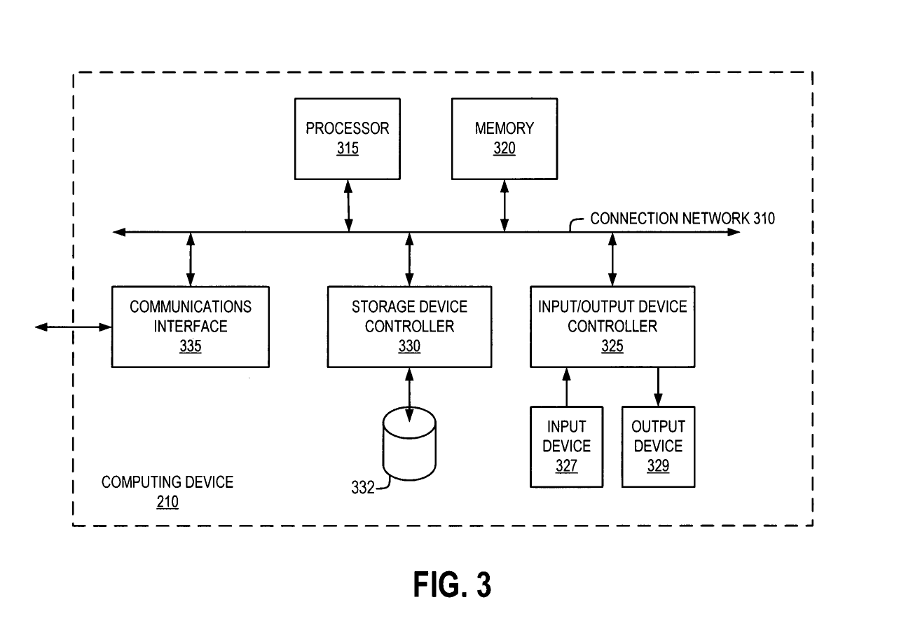

FIG. 3 is a block diagram of a computing device according to an embodiment of the present invention. In the illustrated embodiment, the computing device 210 includes a connection network 310, a processor 315, a memory 320, an input/output device controller 325, an input device 327, an output device 329, a storage device controller 330, and a communications interface 335.

The connection network 310 operatively couples each of the processor 315, the memory 320, the input/output device controller 325, the storage device controller 330, and the communications interface 335. The connection network 310 can be an electrical bus, switch fabric, or other suitable interconnection system.

The processor 315 is a conventional microprocessor. The processor 315 executes instructions or program code modules from the memory 320 or the storage device 322. The operation of the computing device 210 is programmable and configured by the program code modules. Such instructions may be read into memory 320 from a computer readable medium, such as a device coupled to the storage device controller 330.

Execution of the sequences of instructions contained in the memory 320 cause the processor 315 to perform the method or functions described herein. In alternative embodiments, hardwired circuitry may be used in place of or in combination with software instructions to implement aspects of the disclosure. Thus, embodiments of the disclosure are not limited to any specific combination of hardware circuitry and software. The memory 320 can be, for example, one or more conventional random access memory (RAM) devices, conventional flash RAM, or electronically erasable programmable read only memory (EEPROM) devices. The memory 320 may also be used for storing temporary variables or other intermediate information during execution of instructions by processor 315.

The input/output device controller 325 provides an interface to the input device 327 and the output device 329. The output device 329 can be, for example, a conventional display screen. The display screen can include associated hardware, software, or other devices that are needed to generate a screen display. In one embodiment, the output device 329 is a conventional liquid crystal display (LCD). The display screen may also include touch screen capabilities. The illustrated embodiment also includes an input device 327 operatively coupled to the input/output device controller 325. The input device 327 can be, for example, an external or integrated keyboard or cursor control pad.

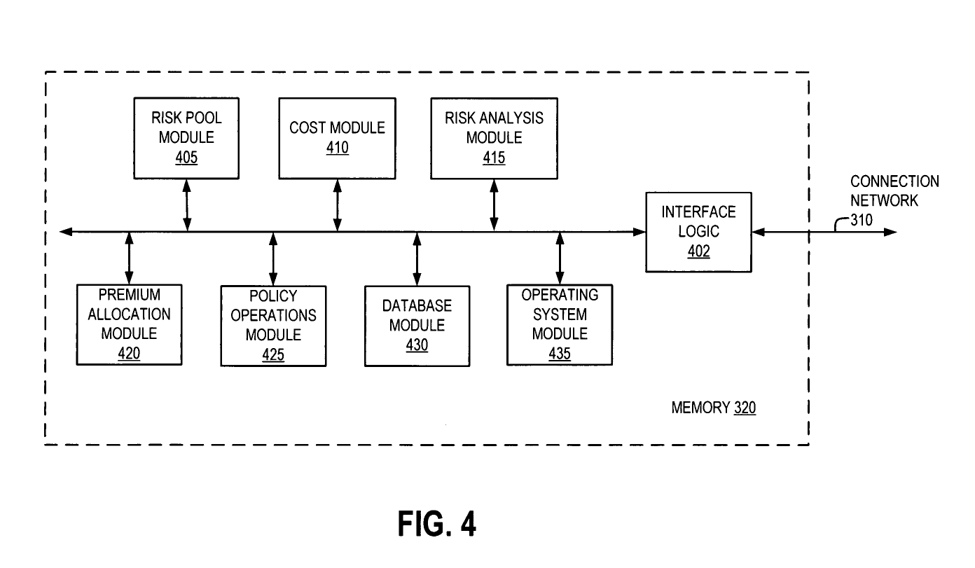

The storage device controller 330 can be used to interface the processor 315 to various memory or storage devices. As one skilled in the art will appreciate, the storage device 332 can be any suitable storage medium, such as magnetic, optical, or electrical storage. Additionally, the storage device 332 or the memory 320 may store and retrieve information that is used by one or more of the functional modules described below and with reference to FIG. 4.

The communications interface 335 provides bidirectional data communication coupling for the computing device 210. The communications interface 335 can be functionally coupled to a network (not illustrated). In one embodiment, the communications interface 335 provides one or more input/output ports for receiving electrical, radio frequency, or optical signals and converts signals received on the port(s) to a format suitable for transmission on the connection network 310. The communications interface 335 can include a radio frequency modem and other logic associated with sending and receiving wireless or wireline communications. For example, the communications interface 335 can provide an Ethernet interface, Bluetooth, and/or 802.11 wireless capability for the computing device 210.

1. Program Code Modules

FIG. 4 illustrates program code modules for an embodiment of the present invention. The illustrated embodiment includes an interface logic 402, a risk pool module 405, a cost module 410, a risk analysis module 415, a premium allocation module 420, a policy operations module 425, a database module 430, and an operating system module 435. The modules 405, 410, 415, 420, 425, 430, 435 are communicatively coupled to the interface logic 402. In an embodiment, the interface logic 402 receives memory address data via the connection network 310. The interface logic 402 also provides program instructions to the processor 315 via the connection network 310.

The modules 405, 410, 415, 420, 425, 430, 435 include program instructions that can be executed on, for example, the processor 315 to implement the features or functions of the present disclosure. The modules 405, 410, 415, 420, 425, 430, 435 are typically stored in a memory, such as the memory 320. As described above, the program instructions can be distributed on a computer readable medium, or storage volume. The computer readable storage volume can be available via a public network, a private network, or the Internet. Program instructions can be in any appropriate form, such as source code, object code, or scripting code. One skilled in the art will recognize that arrangement of the modules 405, 410, 415, 420, 425, 430, 435 represents one example of how the features or functionality of the present disclosure can be implemented. The functionality represented by the modules 405, 410, 415, 420, 425, 430, 435 need not be implemented on a single computing device or host system. In a distributed computing environment, for example, the modules 405, 410, 415, 420, 425, 430, 435 may be distributed among many computing devices.

The cost module 410 includes program instructions to evaluate the parameters of the cost object model 240 to forecast expenditures based on claims asserted against a group of insured parties. The risk pool modules 405 includes program instructions for evaluating the risk pool object model 220 to calculate an overall premium for the group of insured parties based on the forecasted expenditures.

The risk analysis module 415 includes program instructions for evaluating a reserve funding for a particular policy period (e.g., one year). The risk analysis module 415 contemplates most, if not all, potential developments in the cost object 240, such as the indemnity paid component 242, in order to determine whether the balance of risks has been properly considered. In one embodiment, the risk analysis module can generate a risk analysis report 280.

The premium allocation module 420 determines a claims paid insurance premium for the insured party. The premium allocation module 420 operates in conjunction with the risk pool module 405 and the cost module 410 to calculate an overall premium for a group of insured parties. The premium allocation module 420 also operates in conjunction with the database module 430 to apply one or more an adjustment factors, such as risk relativity, risk maturity, geographic or environmental, and policy-specific risk experience, to the portion of the overall premium that is allocated to an insured party.

The policy operations module 425 manages ongoing operations of a claims paid insurance model. The policy operations module 425 ensures that the insured party is obligated to pay the assessed premium without an opportunity to cancel the policy after assessment. The policy operations module 425 also manages the receipt of premium payments and expenditures (e.g., claim defense costs). The policy operations module 425 further ensures that the insurer does not assume liability for a claim against the insured party until the claim has been resolved.

The database module 430 provides data storage and retrieval services for the computing device 210. The database stores information about the insured parties, including risk assessment information and billing information (e.g., premiums charged or assessed).

The operating system module 430 represents a conventional operating system for a computing device, such as a server. Example operating systems include the NonStop system software (which is commercially available from Hewlett-Packard Company of Palo Alto, Calif.). The operating system module 430 provides an application programming interface (API) through which the modules 405, 410, 415, 420, 425, 430, 435 or other application programs interact with the computing device 210. For example, the database module 430 calls a function of the operating system module 435 in order to communicate using the communications interface 335.

Having described embodiments of claims paid insurance (which are intended to be illustrative and not limiting), it is noted that modifications and variations can be made by persons skilled in the art in light of the above teachings. It is therefore to be understood that changes may be made in the particular embodiments of the invention disclosed that are within the scope and spirit of the invention as defined by the appended claims and equivalents.

1. A method for insuring a property or casualty loss of a party with a claims paid insurance policy, the method comprising:
determining a claims paid insurance premium for the insured party;
charging the premium to the insured party;
obligating the insured party to pay the premium without an opportunity to cancel the policy;
receiving payment of the premium from the insured party; and
assuming liability for a claim against the insured party responsive to the claim being resolved.

2. The method of claim 1, wherein determining a claims paid insurance premium further comprises:
evaluating a cost object model to forecast expenditures based on claims asserted against a group of insured parties;
calculating an overall premium for the group of insured parties from the forecasted expenditures; and
allocating a portion of the overall premium to the insured party.

3. The method of claim 2, wherein allocating a portion of the overall premium further comprises:
applying, to the allocated portion, an adjustment factor based at least upon risk relativity, risk maturity, geographic, or policy-specific risk experience.

4. The method of claim 1, further comprising:
receiving, from the insured party, a request for renewal of the claims paid insurance policy; and
granting the request for renewal subject to the determining of the claims paid insurance premium.

5. The method of claim 1, further comprising:
performing a risk review of the insured party;
canceling the claims paid insurance policy of the insured party responsive to the risk review; and
providing tail coverage to the insured party for an open claim.

6. The method of claim 1, further comprising:
defending the claim against the insured party.

7. The method of claim 1, wherein the insured party is indemnified for a loss due to at least one of professional liability, medical professional liability, property liability, and casualty liability.

8. A method for providing a claims paid insurance product, the method comprising:
evaluating a risk pool object model to identify collective risk for a group of entities;
evaluating a cost object model to forecast expenditures based on claims asserted against the group of entities; and
generating a risk analysis for evaluating a reserve funding amount based on the risk pool object model and the cost object model.

9. A system for insuring a property or casualty loss of a party with a claims paid insurance policy, the system comprising:
a premium allocation module configured to determine a claims paid insurance premium for the insured party;
a database module configured to charge the premium to the insured party; and
a policy operations module operatively coupled to the database module and configured to obligate the insured party to pay the premium without an opportunity to cancel the policy, and configured to receive payment of the premium from the insured party, and further configured to assume liability for a claim against the insured party responsive to the claim being resolved.

10. The system of claim 9, further comprising:
a cost module configured to evaluate a cost object model to forecast expenditures based on claims asserted against a group of insured parties; and
a risk pool module configured to calculate an overall premium for the group of insured parties from the forecasted expenditures;
wherein the premium allocation module is further configured to allocate a portion of the overall premium to the insured party.

11. The system of claim 10, wherein the premium allocation module is further configured to apply, to the allocated portion, an adjustment factor based at least upon risk relativity, risk maturity, geographic, or policy-specific risk experience.

12. The system of claim 9, wherein the policy operations module is further configured to receive, from the insured party, a request for renewal of the claims paid insurance policy and to grant the request for renewal subject to the determining of the claims paid insurance premium.

13. The system of claim 9, wherein the policy operations module is further configured to perform a risk review of the insured party, cancel the claims paid insurance policy of the insured party responsive to the risk review, and provide tail coverage to the insured party for an open claim.

14. The system of claim 9, wherein the insured party is indemnified for a loss due to at least one of professional liability, medical professional liability, property liability, and casualty liability.

15. A computing device for modeling a claims paid insurance product, the computing device comprising:
a risk pool module configured to identify collective risk for a group of entities;
a cost module configured to forecast expenditures based on claims asserted against the group of entities; and
a risk analysis module operatively coupled to the risk pool module and the cost module and configured to evaluate a reserve funding amount.
